(19) United States
(12) Patent Application Publication
(10) Pub. No.: US 2023/0043826 A1
(43) Pub. Date: Feb. 9, 2023

(54) PERIODIC REFERENCE SIGNAL (RS) AND RS AVAILABILITY INDICATION SIGNALING FOR FAST ACTIVATION OF SECONDARY CELLS

(71) Applicant: QUALCOMM Incorporated, San Diego, CA (US)

(72) Inventors: Huilin XU, Temecula, CA (US); Kazuki TAKEDA, Tokyo (JP)

(21) Appl. No.: 17/816,854

(22) Filed: Aug. 2, 2022

Related U.S. Application Data
(60) Provisional application No. 63/203,930, filed on Aug. 4, 2021.

(51) Int. Cl. H04W 48/20; H04L 5/00

(52) U.S. Cl. CPC H04W 48/20; H04L 5/0048

(57) ABSTRACT

Some aspects of the present disclosure disclose methods and systems related to the use of a periodic reference signal to activate a secondary cell. For example, a user equipment may receive, from a base station on a primary cell, an activation command configured to activate a secondary cell. The user equipment may also receive, from the base station and on the primary cell, a signal indicating an availability of a periodic reference signal on the secondary cell, the periodic RS being for use in activating the secondary cell. The user equipment may then, in response to receiving the signal, perform a tracking function to activate the secondary cell.

### CROSS-REFERENCE TO RELATED APPLICATIONS

The present disclosure claims the benefit of, and priority to, U.S. Provisional Patent Application No. 63/203,930, filed Aug. 4, 2021, the entirety of which is incorporated by reference herein.

### FIELD OF TECHNOLOGY

The following relates generally to wireless communications and more specifically to the use of a periodic reference signal (RS) and a RS availability indication signaling to activate a secondary cell.

### INTRODUCTION

Wireless communications systems are widely deployed to provide various types of communication content such as voice, video, packet data, messaging, broadcast, and so on. These systems may be capable of supporting communication with multiple users by sharing the available system resources (e.g., time, frequency, and power). A wireless multiple-access communications system may include a number of base stations (BSs), each simultaneously supporting communications for multiple communication devices (e.g., user equipment (UE)).

To meet the growing demands for expanded mobile broadband connectivity, wireless communication technologies are advancing from the long term evolution (LTE) technology to a next generation new radio (NR) technology, which may be referred to as 5^{th} Generation (5G). For example, NR is designed to provide a lower latency, a higher bandwidth or a higher throughput, and a higher reliability than LTE. NR is designed to operate over a wide array of spectrum bands, for example, from low-frequency bands below about 1 gigahertz (GHz) and mid-frequency bands from about 1 GHz to about 6 GHz, to high-frequency bands such as millimeter wave (mmWave) bands. NR is also designed to operate across different spectrum types, from licensed spectrum to unlicensed and shared spectrum.

A UE operating in a multicarrier (i.e., multiple serving frequency bands) system may aggregate certain functions of multiple carriers, such as control and feedback functions, on the same carrier, which may be referred to as a primary carrier or primary component carrier (PCC). A carrier that depends on a primary carrier for support may be referred to as an associated secondary carrier or a secondary component carrier (SCC). ABS transmitting a PCC and a coverage area of that PCC may be referred to as a primary cell (PCell), depending on context, while a BS transmitting a SCC and a coverage area of that SCC may be referred to as a secondary cell (SCell), depending on context.

### BRIEF SUMMARY OF SOME EXAMPLES

The following summarizes some aspects of the present disclosure to provide a basic understanding of the discussed technology. This summary is not an extensive overview of all contemplated features of the disclosure and is intended neither to identify key or critical elements of all aspects of the disclosure nor to delineate the scope of any or all aspects of the disclosure. Its sole purpose is to present some concepts of one or more aspects of the disclosure in summary form as a prelude to the more detailed description that is presented later.

In some aspects, a method of wireless communication performed by a user equipment (UE) comprises receiving, from a base station (BS) and on a primary cell (PCell), an activation command configured to activate a secondary cell (SCell). The method further comprises receiving, from the BS and on the PCell, a signaling configured to indicate availability of a periodic reference signal (RS) that is different from a synchronization signal block (SSB) on the SCell for use in activating the SCell. In addition, the method comprises performing, in response to the receiving the signaling, tracking loop for the activating the SCell.

In some aspects of the present disclosure, a user equipment (UE) comprises a memory; a processor coupled to the memory and a transceiver coupled to the processor. In some aspects, the transceiver is configured to receive, from a base station (BS) and on a primary cell (PCell), an activation command configured to activate a secondary cell (SCell). Further, the transceiver is configured to receive, from the BS and on the PCell, a signaling configured to indicate availability of a periodic reference signal (RS) that is different from a synchronization signal block (SSB) on the SCell for use in activating the SCell. Further, the processor can be configured to perform, in response to the signaling being received, tracking loop to activate the SCell.

Some aspects of the present disclosure disclose a non-transitory computer-readable medium (CRM) having program code recorded thereon. In some aspects, the program code comprises code for causing a user equipment (UE) to receive, from a base station (BS) and on a primary cell (PCell), an activation command configured to activate a secondary cell (SCell). Further, the program code comprises code for causing the UE to receive, from the BS and on the PCell, a signaling configured to indicate availability of a periodic reference signal (RS) that is different from a synchronization signal block (SSB) on the SCell for use in activating the SCell. In addition, the program code comprises code for causing the UE to perform, in response to the signaling being received, tracking loop to activate the SCell.

Some aspects of the present disclosure disclose a user equipment (UE), comprising: means for receiving, from a base station (BS) and on a primary cell (PCell), an activation command configured to activate a secondary cell (SCell). Further, the UE comprises means for receiving, from the BS and on the PCell, a signaling configured to indicate availability of a periodic reference signal (RS) that is different from a synchronization signal block (SSB) on the SCell for use in activating the SCell. In addition, the UE comprises means for performing, in response to the receiving the signaling, tracking loop for the activating the SCell.

Other aspects, features, and embodiments will become apparent to those of ordinary skill in the art, upon reviewing the following description of specific, exemplary embodiments in conjunction with the accompanying figures. While features may be discussed relative to certain embodiments and figures below, all embodiments can include one or more of the advantageous features discussed herein. In other words, while one or more embodiments may be discussed as having certain advantageous features, one or more of such features may also be used in accordance with the various embodiments discussed herein. In similar fashion, while exemplary embodiments may be discussed below as device, system, or method embodiments it should be understood that such exemplary embodiments can be implemented in various devices, systems, and methods.

### BRIEF DESCRIPTION OF THE DRAWINGS

FIG. 1 illustrates a wireless communication network, according to some aspects of the present disclosure.

FIG. 2 illustrates a radio frame structure, according to some aspects of the present disclosure.

FIG. 3 shows an example illustration of the use of a periodic reference signal and a RS availability indication signaling for fast activation of a secondary cell, according to some aspects of the present disclosure.

FIG. 4 shows an example illustration of the use of a periodic reference signal and a RS availability indication signaling for fast activation of a secondary cell in the presence of a synchronization signal block, according to some aspects of the present disclosure.

FIG. 5 shows an example illustration of the use of multiple periodic reference signals and a RS availability indication signaling for fast activation of a secondary cell, according to some aspects of the present disclosure.

FIG. 6 is a block diagram of an exemplary user equipment (UE), according to some aspects of the present disclosure.

FIG. 7 is a block diagram of an exemplary base station (BS), according to aspects of the present disclosure.

FIG. 8 illustrates a flow diagram of a wireless communication method, according to some aspects of the present disclosure.

### DETAILED DESCRIPTION

The detailed description set forth below, in connection with the appended drawings, is intended as a description of various configurations and is not intended to represent the only configurations in which the concepts described herein may be practiced. The detailed description includes specific details for the purpose of providing a thorough understanding of the various concepts. However, it will be apparent to those skilled in the art that these concepts may be practiced without these specific details. In some instances, well-known structures and components are shown in block diagram form in order to avoid obscuring such concepts.

This disclosure relates generally to wireless communications systems, also referred to as wireless communications networks. In various embodiments, the techniques and apparatus may be used for wireless communication networks such as code division multiple access (CDMA) networks, time division multiple access (TDMA) networks, frequency division multiple access (FDMA) networks, orthogonal FDMA (OFDMA) networks, single-carrier FDMA (SC-FDMA) networks, LTE networks, Global System for Mobile Communications (GSM) networks, 5^{th} Generation (5G) or new radio (NR) networks, as well as other communications networks. As described herein, the terms “networks” and “systems” may be used interchangeably.

An OFDMA network may implement a radio technology such as evolved UTRA (E-UTRA), Institute of Electrical and Electronics Engineers (IEEE) 802.11, IEEE 802.16, IEEE 802.20, flash-OFDM and the like. UTRA, E-UTRA, and GSM are part of universal mobile telecommunication system (UMTS). In particular, long term evolution (LTE) is a release of UMTS that uses E-UTRA. UTRA, E-UTRA, GSM, UMTS and LTE are described in documents provided from an organization named “3rd Generation Partnership Project” (3GPP), and cdma2000 is described in documents from an organization named “3rd Generation Partnership Project 2” (3GPP2). These various radio technologies and standards are known or are being developed. For example, the 3rd Generation Partnership Project (3GPP) is a collaboration between groups of telecommunications associations that aims to define a globally applicable third generation (3G) mobile phone specification. 3GPP long term evolution (LTE) is a 3GPP project which was aimed at improving the UMTS mobile phone standard. The 3GPP may define specifications for the next generation of mobile networks, mobile systems, and mobile devices. The present disclosure is concerned with the evolution of wireless technologies from LTE, 4G, 5G, NR, and beyond with shared access to wireless spectrum between networks using a collection of new and different radio access technologies or radio air interfaces.

In particular, 5G networks contemplate diverse deployments, diverse spectrum, and diverse services and devices that may be implemented using an OFDM-based unified, air interface. In order to achieve these goals, further enhancements to LTE and LTE-A are considered in addition to development of the new radio technology for 5G NR networks. The 5G NR will be capable of scaling to provide coverage (1) to a massive Internet of things (IoTs) with a ultra-high density (e.g., ˜1M nodes/km²), ultra-low complexity (e.g., ˜10s of bits/sec), ultra-low energy (e.g., —10+ years of battery life), and deep coverage with the capability to reach challenging locations; (2) including mission-critical control with strong security to safeguard sensitive personal, financial, or classified information, ultra-high reliability (e.g., 99.9999% reliability), ultra-low latency (e.g., ˜1 ms), and users with wide ranges of mobility or lack thereof; and (3) with enhanced mobile broadband including extreme high capacity (e.g., ˜10 Tbps/km²), extreme data rates (e.g., multi-Gbps rate, 100+ Mbps user experienced rates), and deep awareness with advanced discovery and optimizations.

A 5G NR communication system may be implemented to use optimized OFDM-based waveforms with scalable numerology and transmission time interval (TTI). Additional features may also include having a common, flexible framework to efficiently multiplex services and features with a dynamic, low-latency time division duplex (TDD)/frequency division duplex (FDD) design; and with advanced wireless technologies, such as massive multiple input, multiple output (MIMO), robust millimeter wave (mmWave) transmissions, advanced channel coding, and device-centric mobility. Scalability of the numerology in 5G NR, with scaling of subcarrier spacing, may efficiently address operating diverse services across diverse spectrum and diverse deployments. For example, in various outdoor and macro coverage deployments of less than 3 GHz FDD/TDD implementations, subcarrier spacing may occur with 15 kHz, for example over 5, 10, 20 MHz, and the like bandwidth (BW). For other various outdoor and small cell coverage deployments of TDD greater than 3 GHz, subcarrier spacing may occur with 30 kHz over 80/100 MHz BW. For other various indoor wideband implementations, using a TDD over the unlicensed portion of the 5 GHz band, the subcarrier spacing may occur with 60 kHz over a 160 MHz BW. Finally, for various deployments transmitting with mmWave components at a TDD of 28 GHz, subcarrier spacing may occur with 120 kHz over a 500 MHz BW. In some aspects, 5G NR may be described as operating in two frequency ranges: FR1, which includes frequency bands of about 7 GHz and lower (e.g., 410 MHz to 7125 MHz), and FR2, which includes frequency bands between about 24.25 GHz and about 52.6 GHz, which may be referred to as the mmWave.

The scalable numerology of the 5G NR facilitates scalable TTI for diverse latency and quality of service (QoS) requirements. For example, shorter TTI may be used for low latency and high reliability, while longer TTI may be used for higher spectral efficiency. The efficient multiplexing of long and short TTIs to allow transmissions to start on symbol boundaries. 5G NR also contemplates a self-contained integrated subframe design with UL/downlink scheduling information, data, and acknowledgement in the same subframe. The self-contained integrated subframe supports communications in unlicensed or contention-based shared spectrum, adaptive UL/downlink that may be flexibly configured on a per-cell basis to dynamically switch between UL and downlink to meet the current traffic needs.

Various other aspects and features of the disclosure are further described below. It should be apparent that the teachings herein may be embodied in a wide variety of forms and that any specific structure, function, or both being disclosed herein is merely representative and not limiting. Based on the teachings herein one of an ordinary level of skill in the art should appreciate that an aspect disclosed herein may be implemented independently of any other aspects and that two or more of these aspects may be combined in various ways. For example, an apparatus may be implemented or a method may be practiced using any number of the aspects set forth herein. In addition, such an apparatus may be implemented or such a method may be practiced using other structure, functionality, or structure and functionality in addition to or other than one or more of the aspects set forth herein. For example, a method may be implemented as part of a system, device, apparatus, and/or as instructions stored on a computer readable medium for execution on a processor or computer. Furthermore, an aspect may comprise at least one element of a claim.

In some instances, for instance to transfer data at a higher rate, a UE and a BS may communicate over multiple frequency bands in parallel (a form of carrier aggregation (CA)). In this configuration, one of the bands can be associated with a primary cell (PCell) and another with a secondary cell (SCell). In some aspects, a UE communicating with a BS over a single PCell, or anchor cell, may activate an SCell for CA by receiving an activation command from the BS over the PCell, and performing measurements of SSBs transmitted on the SCell. SSBs include reference signals, such as primary synchronization signals (PSS), secondary synchronization signal (SSS), and demodulation reference signals (DM-RS). The UE can perform measurements of the reference signals to perform various functions to establish and maintain communication over a given cell, such as but not limited to power tracking loops (e.g., automatic gain control (AGC), etc.), frequency tracking loops, time tracking loops, and cell detection.

Tracking loops may include, for example, frequency tracking loops (FTL), time tracking loops (TTL), and power tracking loops (e.g., automatic gain control (AGC), etc.). Regarding FTL, the UE may track the frequency error at the UE or a frequency difference between the UE and the BS based on the frequency of reference signals (RS) that are transmitted by the BS. The frequency error or difference is used as a feedback for a frequency correction. Regarding TTL, the UE may track the change in transmission time between the UE and the BS. The time delay (or delay spread) is used to determine the optimal window of data samples to process with a Fast Fourier Transform (FFT) to extract the OFDM signaling. In general, the UE may perform the FTL and TTL to synchronize the frequency and time references of the UE to the frequency and time at the BS, respectively. The receiver AGC algorithm may be designed to maintain a constant signal power at the input to the demodulator. In some instances, the AGC can be implemented through the mechanism of two loops: an outer loop, and an inner loop. The outer loop controls the low-noise amplifier (LNA) gain state in RF (i.e., by increasing or decreasing amplifier gain); the LNA gain state can compensate for coarse gain variations. In contrast, the inner loop estimates and adjusts the digital variable gain control (DVGA) to maintain a constant set-point for the signal power at the input to the demodulator.

SSBs are detected and used by UEs during cell search and activation procedures to activate a cell. SSBs are transmitted via the SCell with an SSB periodicity, which may be one SSB or SSB burst every 20 ms, 40 ms, 80 ms, or any suitable periodicity. The relatively sparse SSBs in the SCell can increase the delay from the time the UE receives the SCell activation command to the time the SCell is activated for operation. For example, if a UE receives an SCell activation command after or shortly before (e.g., <2 ms before) an SSB is transmitted, the UE waits for a full SSB period (e.g., 20 ms) before the UE can perform the measurements involved with the cell activation. The increased delay to activate an SCell for CA can result in suboptimal performance and user experience.

Further, the use of SSBs by a UE to perform tracking loop functions for idle mode operations may reduce the UE's deep sleep time and lead to increased power consumption. While in an idle mode, a UE may perform signal measurements and cell search. That is, in a radio access network such as a NR network, a BS may transmit synchronization signals to allow UEs to search and acquire synchronization to a cell within the radio access network, and the UE may perform signal measurements and cell search. During the search phase, the UE may blindly search for new cells during a measurement window. During the measurement phase, the UE may be unable to identify new cells, but may measure reference signal received power (RSRP), reference signal received quality (RSRQ), and/or signal-to-interference-plus-noise ratio (SINR) for all detected cells. For example, the UE may search for and measure SSBs, and select the cell that provides the UE with a SSB having the best signal strength or quality (e.g., highest RSRP, highest RSRQ, or highest SINR) as the serving cell. After selecting the serving cell, the UE may monitor the serving cell and/or neighbor cells for better signal strength or quality compared to the serving cell (e.g., higher RSRP than the RSRP associated with the serving cell, higher RSRQ than the RSRQ associated with the serving cell, and/or higher SINR than the SINR associated with the serving cell).

In some instances, the UE may be configured with paging occasions (e.g., at certain time periods) for idle mode operations. While the UE is in the idle mode, the UE may wake up to monitor for paging from the network during a paging occasion. The UE may enable or perform the afore-mentioned tracking loops on a SSB (e.g., SSB associated with the serving cell) before a paging occasion to provide timing and/or frequency updates for decoding a page. The SSB measurements for idle mode operations, however, may contribute to increased power consumption by the UE, because the measurements reduce the UE's deep sleep time.

Aspects of the present disclosure provide mechanisms for activating an SCell based on activation command from a BS and one or more periodic reference signals (RSs), non-limiting examples of which include tracking reference signals (TRS). In some instances, the periodic RSs can be transmitted more frequently than SSBs. In some instances, the periodic RSs can be used in place of, or in addition to, the SSBs by UEs for tracking functions (e.g., power tracking (e.g., AGC), time tracking, frequency tracking, etc.). The temporary RSs can be triggered by the BS, and may be associated with or based on the activation command from the BS to activate the SCell. The BS may indicate to the UE the timing (e.g., slot number) and configuration of the periodic RS in downlink information, such as one or more system information blocks (SIBs), a downlink control information (DCI) in a physical downlink control channel (PDCCH), or a media access control-control element (MAC-CE) in a physical downlink shared channel (PDSCH). The BS may also provide an additional signaling, an availability indication signaling, to signal to the UE the presence or the availability of the periodic RS for use in the activation of the SCell. In some instances, by transmitting the activation command configured to activate the activation of the SCell, by triggering one or more of the periodic RSs associated with an SCell activation command, and indicating the triggering to the UE (i.e., indicating the availability of the one or more periodic RSs using an availability indication signaling), the delay associated with activating the Scell can be reduced and facilitate the fast activation of the SCell. That is, the BS and UE can begin operation on the SCell sooner, thereby improving performance and user experience.

As used herein, the “periodic reference signal” that is used for SCell activation purposes as discussed in the subject application, may refer to a reference signal that is not part of an SSB and is configured for use by the UE in performing functions related to the SCell activation, such functions including but not limited to the UE performing power tracking loops (e.g., AGC), frequency tracking loops, time tracking loops, and/or the like, during cell activation. In some aspects, the one or more periodic reference signals that are used for SCell activation may occur within an activation time window of the SCell, and may not be present after the SCell is activated. That is, in some aspects, the periodic reference signals that are transmitted by the BS to the UE and that may be used by the UE for SCell activation purposes are those that are within an activation time window of the SCell.

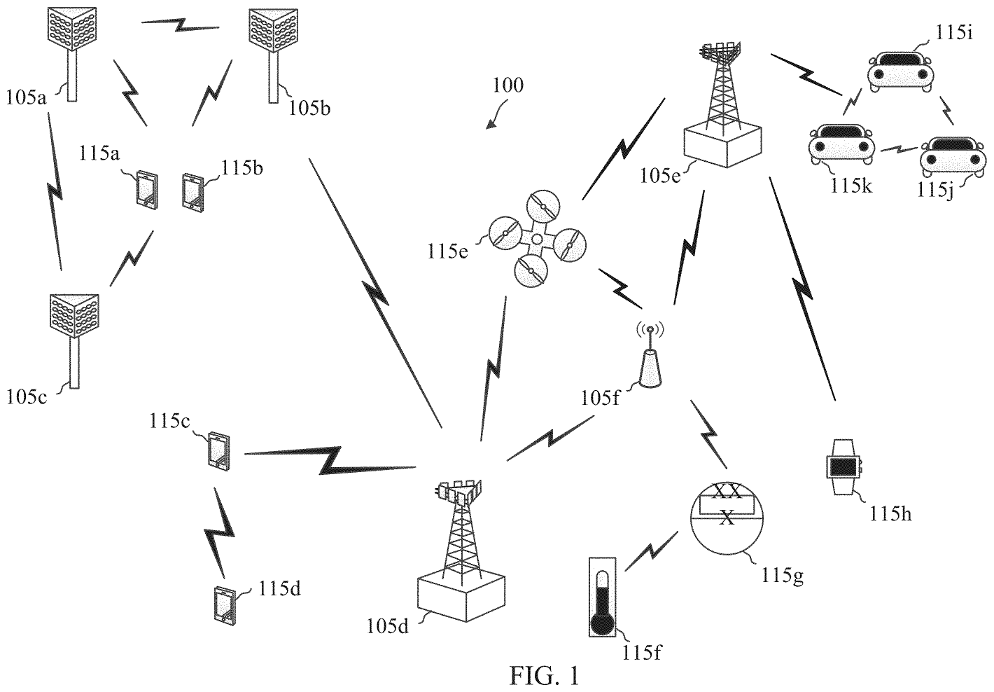

FIG. 1 illustrates a wireless communication network 100 according to some aspects of the present disclosure. The network 100 may be a 5G network. The network 100 includes a number of base stations (BSs) 105 (individually labeled as 105a, 105b, 105c, 105d, 105e, and 105f) and other network entities. ABS 105 may be a station that communicates with UEs 115 and may also be referred to as an evolved node B (eNB), a next generation eNB (gNB), an access point, and the like. Each BS 105 may provide communication coverage for a particular geographic area. In 3GPP, the term “cell” can refer to this particular geographic coverage area of a BS 105 and/or a BS subsystem serving the coverage area, depending on the context in which the term is used.

A BS 105 may provide communication coverage for a macro cell or a small cell, such as a pico cell or a femto cell, and/or other types of cell. A macro cell generally covers a relatively large geographic area (e.g., several kilometers in radius) and may allow unrestricted access by UEs with service subscriptions with the network provider. A small cell, such as a pico cell, would generally cover a relatively smaller geographic area and may allow unrestricted access by UEs with service subscriptions with the network provider. A small cell, such as a femto cell, would also generally cover a relatively small geographic area (e.g., a home) and, in addition to unrestricted access, may also provide restricted access by UEs having an association with the femto cell (e.g., UEs in a closed subscriber group (CSG), UEs for users in the home, and the like). ABS for a macro cell may be referred to as a macro BS. A BS for a small cell may be referred to as a small cell BS, a pico BS, a femto BS or a home BS. In the example shown in FIG. 1, the BSs 105d and 105e may be regular macro BSs, while the BSs 105a-105c may be macro BSs enabled with one of three dimension (3D), full dimension (FD), or massive MIMO. The BSs 105a-105c may take advantage of their higher dimension MIMO capabilities to exploit 3D beamforming in both elevation and azimuth beamforming to increase coverage and capacity. The BS 105f may be a small cell BS which may be a home node or portable access point. A BS 105 may support one or multiple (e.g., two, three, four, and the like) cells.

The network 100 may support synchronous or asynchronous operation. For synchronous operation, the BSs may have similar frame timing, and transmissions from different BSs may be approximately aligned in time. For asynchronous operation, the BSs may have different frame timing, and transmissions from different BSs may not be aligned in time.

The UEs 115 are dispersed throughout the wireless network 100, and each UE 115 may be stationary or mobile. A UE 115 may also be referred to as a terminal, a mobile station, a subscriber unit, a station, or the like. A UE 115 may be a cellular phone, a personal digital assistant (PDA), a wireless modem, a wireless communication device, a handheld device, a tablet computer, a laptop computer, a cordless phone, a wireless local loop (WLL) station, or the like. In one aspect, a UE 115 may be a device that includes a Universal Integrated Circuit Card (UICC). In another aspect, a UE may be a device that does not include a UICC. In some aspects, the UEs 115 that do not include UICCs may also be referred to as IoT devices or internet of everything (IoE) devices. The UEs 115a-115d are examples of mobile smart phone-type devices accessing network 100. A UE 115 may also be a machine specifically configured for connected communication, including machine type communication (MTC), enhanced MTC (eMTC), narrowband IoT (NB-IoT) and the like. The UEs 115e-115h are examples of various machines configured for communication that access the network 100. The UEs 115i-115k are examples of vehicles equipped with wireless communication devices configured for communication that access the network 100. A UE 115 may be able to communicate with any type of the BSs, whether macro BS, small cell, or the like. In FIG. 1, a lightning bolt (e.g., communication links) indicates wireless transmissions between a UE 115 and a serving BS 105, which is a BS designated to serve the UE 115 on the downlink (DL) and/or uplink (UL), desired transmission between BSs 105, backhaul transmissions between BSs, or sidelink transmissions between UEs 115.

In operation, the BSs 105a-105c may serve the UEs 115a and 115b using 3D beamforming and coordinated spatial techniques, such as coordinated multipoint (CoMP) or multi-connectivity. The macro BS 105d may perform backhaul communications with the BSs 105a-105c, as well as small cell, the BS 105f. The macro BS 105d may also transmit multicast services which are subscribed to and received by the UEs 115c and 115d. Such multicast services may include mobile television or stream video, or may include other services for providing community information, such as weather emergencies or alerts, such as Amber alerts or gray alerts.

The BSs 105 may also communicate with a core network. The core network may provide user authentication, access authorization, tracking, Internet Protocol (IP) connectivity, and other access, routing, or mobility functions. At least some of the BSs 105 (e.g., which may be an example of a gNB or an access node controller (ANC)) may interface with the core network through backhaul links (e.g., NG-C, NG-U, etc.) and may perform radio configuration and scheduling for communication with the UEs 115. In various examples, the BSs 105 may communicate, either directly or indirectly (e.g., through core network), with each other over backhaul links (e.g., X1, X2, etc.), which may be wired or wireless communication links.

The network 100 may also support mission critical communications with ultra-reliable and redundant links for mission critical devices, such as the UE 115e, which may be a drone. Redundant communication links with the UE 115e may include links from the macro BSs 105d and 105e, as well as links from the small cell BS 105f. Other machine type devices, such as the UE 115f (e.g., a thermometer), the UE 115g (e.g., smart meter), and UE 115h (e.g., wearable device) may communicate through the network 100 either directly with BSs, such as the small cell BS 105f, and the macro BS 105e, or in multi-step-size configurations by communicating with another user device which relays its information to the network, such as the UE 115f communicating temperature measurement information to the smart meter, the UE 115g, which is then reported to the network through the small cell BS 105f. The network 100 may also provide additional network efficiency through dynamic, low-latency TDD/FDD communications, such as V2V, V2X, C-V2X communications between a UE 115i, 115j, or 115k and other UEs 115, and/or vehicle-to-infrastructure (V2I) communications between a UE 115i, 115j, or 115k and a BS 105.

In some implementations, the network 100 utilizes OFDM-based waveforms for communications. An OFDM-based system may partition the system BW into multiple (K) orthogonal subcarriers, which are also commonly referred to as subcarriers, tones, bins, or the like. Each subcarrier may be modulated with data. In some instances, the subcarrier spacing between adjacent subcarriers may be fixed, and the total number of subcarriers (K) may be dependent on the system BW. The system BW may also be partitioned into subbands. In other instances, the subcarrier spacing and/or the duration of TTIs may be scalable.

In some aspects, the BSs 105 can assign or schedule transmission resources (e.g., in the form of time-frequency resource blocks (RB)) for downlink (DL) and uplink (UL) transmissions in the network 100. DL refers to the transmission direction from a BS 105 to a UE 115, whereas UL refers to the transmission direction from a UE 115 to a BS 105. The communication can be in the form of radio frames. A radio frame may be divided into a plurality of subframes or slots, for example, about 10. Each slot may be further divided into mini-slots. In a FDD mode, simultaneous UL and DL transmissions may occur in different frequency bands. For example, each subframe includes a UL subframe in a UL frequency band and a DL subframe in a DL frequency band. In a TDD mode, UL and DL transmissions occur at different time periods using the same frequency band. For example, a subset of the subframes (e.g., DL subframes) in a radio frame may be used for DL transmissions and another subset of the subframes (e.g., UL subframes) in the radio frame may be used for UL transmissions.

The DL subframes and the UL subframes can be further divided into several regions. For example, each DL or UL subframe may have pre-defined regions for transmissions of reference signals, control information, and data. Reference signals are predetermined signals that facilitate the communications between the BSs 105 and the UEs 115. For example, a reference signal can have a particular pilot pattern or structure, where pilot tones may span across an operational BW or frequency band, each positioned at a pre-defined time and a pre-defined frequency. For example, a BS 105 may transmit cell specific reference signals (CRSs) and/or channel state information—reference signals (CSI-RSs) to enable a UE 115 to estimate a DL channel. Similarly, a UE 115 may transmit sounding reference signals (SRSs) to enable a BS 105 to estimate a UL channel. Control information may include resource assignments and protocol controls. Data may include protocol data and/or operational data. In some aspects, the BSs 105 and the UEs 115 may communicate using self-contained subframes. A self-contained subframe may include a portion for DL communication and a portion for UL communication. A self-contained subframe can be DL-centric or UL-centric. A DL-centric subframe may include a longer duration for DL communication than for UL communication. A UL-centric subframe may include a longer duration for UL communication than for UL communication.

In some aspects, the network 100 may be a NR network deployed over a licensed spectrum. The BSs 105 can transmit synchronization signals (e.g., including a primary synchronization signal (PSS) and a secondary synchronization signal (SSS)) in the network 100 to facilitate synchronization. The BSs 105 can broadcast system information associated with the network 100 (e.g., including a master information block (MIB), remaining system information (RMSI), and other system information (OSI)) to facilitate initial network access. In some instances, the BSs 105 may broadcast the PSS, the SSS, and/or the MIB in the form of synchronization signal block (SSBs) over a physical broadcast channel (PBCH) and may broadcast the RMSI and/or the OSI over a physical downlink shared channel (PDSCH).

In some aspects, a UE 115 attempting to access the network 100 may perform an initial cell search by detecting a PSS from a BS 105. The PSS may enable synchronization of period timing and may indicate a physical layer identity value. The UE 115 may then receive a SSS. The SSS may enable radio frame synchronization, and may provide a cell identity value, which may be combined with the physical layer identity value to identify the cell. The PSS and the SSS may be located in a central portion of a carrier or any suitable frequencies within the carrier.

After receiving the PSS and SSS, the UE 115 may receive a MIB. The MIB may include system information for initial network access and scheduling information for RMSI and/or OSI. After decoding the MIB, the UE 115 may receive RMSI and/or OSI. The RMSI and/or OSI may include radio resource control (RRC) information related to random access channel (RACH) procedures, paging, control resource set (CORESET) for physical downlink control channel (PDCCH) monitoring, physical UL control channel (PUCCH), physical UL shared channel (PUSCH), power control, and SRS.

After obtaining the MIB, the RMSI and/or the OSI, the UE 115 can perform a random access procedure to establish a connection with the BS 105. In some examples, the random access procedure may be a four-step random access procedure. For example, the UE 115 may transmit a random access preamble and the BS 105 may respond with a random access response. The random access response (RAR) may include a detected random access preamble identifier (ID) corresponding to the random access preamble, timing advance (TA) information, a UL grant, a temporary cell-radio network temporary identifier (C-RNTI), and/or a backoff indicator. Upon receiving the random access response, the UE 115 may transmit a connection request to the BS 105 and the BS 105 may respond with a connection response. The connection response may indicate a contention resolution. In some examples, the random access preamble, the RAR, the connection request, and the connection response can be referred to as message 1 (MSG1), message 2 (MSG2), message 3 (MSG3), and message 4 (MSG4), respectively. In some examples, the random access procedure may be a two-step random access procedure, where the UE 115 may transmit a random access preamble and a connection request in a single transmission and the BS 105 may respond by transmitting a random access response and a connection response in a single transmission.

After establishing a connection, the UE 115 and the BS 105 can enter a normal operation stage, where operational data may be exchanged. For example, the BS 105 may schedule the UE 115 for UL and/or DL communications. The BS 105 may transmit UL and/or DL scheduling grants to the UE 115 via a PDCCH. The scheduling grants may be transmitted in the form of DL control information (DCI). The BS 105 may transmit a DL communication signal (e.g., carrying data) to the UE 115 via a PDSCH according to a DL scheduling grant. The UE 115 may transmit a UL communication signal to the BS 105 via a PUSCH and/or PUCCH according to a UL scheduling grant.

In some aspects, the network 100 may operate over a system BW or a component carrier (CC) BW. The network 100 may partition the system BW into multiple BWPs (e.g., portions). A BS 105 may dynamically assign a UE 115 to operate over a certain BWP (e.g., a certain portion of the system BW). The assigned BWP may be referred to as the active BWP. The UE 115 may monitor the active BWP for signaling information from the BS 105. The BS 105 may schedule the UE 115 for UL or DL communications in the active BWP. In some aspects, a BS 105 may assign a pair of BWPs within the CC to a UE 115 for UL and DL communications. For example, the BWP pair may include one BWP for UL communications and one BWP for DL communications.

In some aspects, the network 100 may be an NR network supporting carrier aggregation (CA) of component carriers (CCs) in which more than one cell can be activated to support DL/UL transmissions. Each cell may correspond to a different CC, and may be within a same frequency band or within different frequency bands.

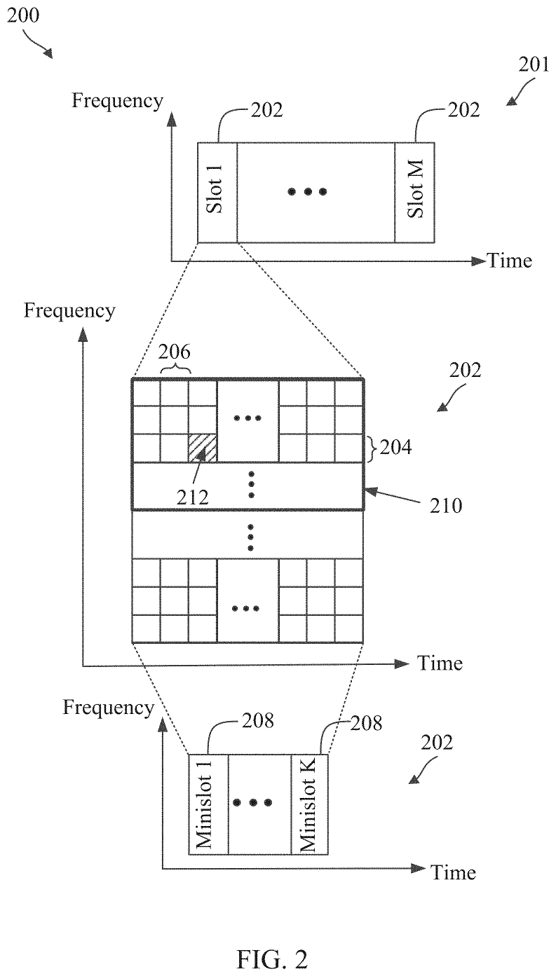

FIG. 2 illustrates a radio frame structure 200 according to some aspects of the present disclosure. The radio frame structure 200 may be employed by BSs such as the BSs 105 and UEs such as the UEs 115 in a network such as the network 100 for communications. In particular, the BS may communicate with the UE using time-frequency resources configured as shown in the radio frame structure 200. In FIG. 2, the x-axes represent time in some arbitrary units and the y-axes represent frequency in some arbitrary units. The transmission frame structure 200 includes a radio frame 201. The duration of the radio frame 201 may vary depending on the aspects. In an example, the radio frame 201 may have a duration of about ten milliseconds. The radio frame 201 includes M number of slots 202, where M may be any suitable positive integer. In an example, M may be about 10.

Each slot 202 includes a number of subcarriers 204 in frequency and a number of symbols 206 in time. The number of subcarriers 204 and/or the number of symbols 206 in a slot 202 may vary depending on the aspects, for example, based on the channel BW, the subcarrier spacing (SCS), and/or the CP mode. One subcarrier 204 in frequency and one symbol 206 in time forms one resource element (RE) 212 for transmission. A resource block (RB) 210 is formed from a number of consecutive subcarriers 204 in frequency and a number of consecutive symbols 206 in time.

In an example, a BS (e.g., BS 105 in FIG. 1) may schedule a UE (e.g., UE 115 in FIG. 1) for UL and/or DL communications at a time-granularity of slots 202 or mini-slots 208. Each slot 202 may be time-partitioned into K number of mini-slots 208. Each mini-slot 208 may include one or more symbols 206. The mini-slots 208 in a slot 202 may have variable lengths. For example, when a slot 202 includes N number of symbols 206, a mini-slot 208 may have a length between one symbol 206 and (N−1) symbols 206. In some aspects, a mini-slot 208 may have a length of about two symbols 206, about four symbols 206, or about seven symbols 206. In some examples, the BS may schedule UE at a frequency-granularity of a resource block (RB) 210 (e.g., including about 12 subcarriers 204).

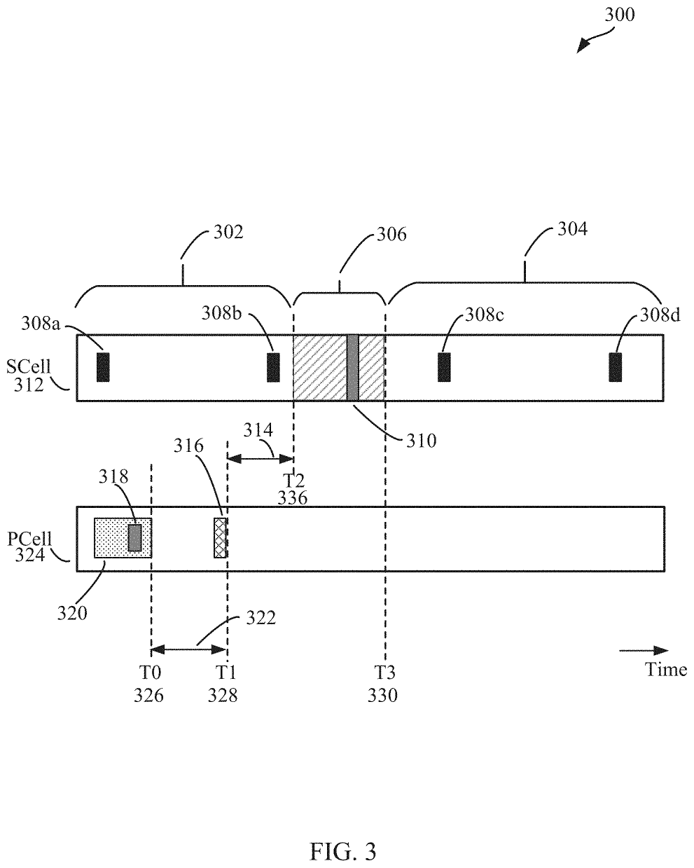

In some aspects, FIG. 3 shows a PCell 324 and an SCell 312. The PCell 324, or primary cell or primary secondary cell for the secondary cell group if dual connectivity is configured, may be an anchor cell on which the UE receives control information and configurations from the BS. Further, for instance to offload DL and/or UL traffic from the PCell 324, the BS can activate a secondary cell SCell 312 in a carrier aggregation (CA) communication scheme. For example, the BS may transmit an activation command 320 to the UE on the PCell 324 that is configured to trigger the activation of the SCell 312. That is, the SCell 312 may be in a deactivated phase 302 and the BS may transmit, on the PCell 324 and to the UE, an activation command 320 that is configured to activate the SCell 312 that is in the deactivated phase 302. In some aspects, the SCell 312 may be known to the UE. For example, in some aspects, the UE may have previously activated and then deactivated the SCell 312. Accordingly, the UE may have stored configuration information (e.g., SSB transmission parameters, system information, receive signal strength) associated with the SCell 312 that can be used in reactivating the SCell 312. In other aspects, the SCell 312 may be unknown to the UE.

In some instances, activating the SCell 312 may include the UE detecting or measuring synchronization signal blocks (SSBs) 308 transmitted on the SCell 312 to perform tracking loops such as power tracking loops (e.g., automatic gain control (AGC)), frequency tracking loops, time tracking loops, etc. In some cases, the protocols associated with activating the SCell 312 may cause a delay from the time the BS 105 transmits an SCell activation command 320 on the PCell until the time the Scell activation is complete.

In some aspects, because the SSBs 308 can be sparse, i.e., because the periodicity of the SSB transmission from the BS, the time difference between successive SSBs 308 transmitted to the UE on the Scell, can be large, there may be a significant delay between the activation command 320 being transmitted to the UE on the PCell 324 at time T0 326 and the activation of the SCell at a later time. For example, the activation command 320 may not take effect until time T2, which may occur after the SSB 308b is transmitted by the BS and well before the transmittal of the next SSB 308c, which means that there can be a significant delay between the arrival of the activation command 320 at the UE and the detection and measurement of the next SSB 308c by the UE for use in activating the SCell 312.

In some aspects, a faster activation of the SCell 312 may be facilitated (e.g., in comparison to the case where the SSB 308c is used for performing tracking functions) by using a periodic RS 310 and an RS availability indication signaling 318 transmitted by the BS to the UE on the SCell 312 and on the PCell 324, respectively. That is, in some instances, the BS may configure periodic RS occasions on the SCell 312 for receiving, at the UE, reference signals transmitted by the BS. For example, the RS occasions can be configured on the SCell 312 to receive at the UE periodic tracking RS (TRS) transmitted by the UE. In some instances, the configuration of the RS occasions can be based on a system information block (SIB). That is, the BS may transmit to the UE SIBs carrying configuration information to configure the RS occasions on the SCell 312 for receiving reference signals at the UE. As noted above, in some cases, the RS occasions may be periodic TRS occasions, i.e., the RS occasions may be configured for receiving periodic TRS. In some aspects, the periodic RS 310 on SCell 312 may be different from the SSBs 308 on the SCell 312. That is, the periodic RS 310 may not be a reference signal carried by a synchronization signal block, but rather a reference signal that is different from, and not carried by, a SSB.

In some instances, the periodic RS 310 transmitted via the configured RS occasions may also be used for idle or inactive mode operation purposes by a UE that in an idle or inactive mode. For example, the BS may configure periodic RS occasions on the SCell 312 for the UE to receive periodic RS 310 from the BS and transmit said periodic RS 310 via the configured RS occasions to allow the UE to perform signal measurements and cell search. In such cases, the periodic RS 310 may be a periodic TRS. In some instances, the UE may use the received periodic RS 310 to perform tracking loop functions for the idle or inactive mode operations.

In some instances, the BS may also transmit, on the PCell 324 and to the UE, the RS availability indication signaling 318 that is configured to indicate the availability of the periodic RS 310 on the SCell 312. The RS availability indication signaling 318 may be a dynamic indication from the BS to the UE about the presence or availability of the periodic RS 310 for the UE to use the periodic RS 310 for SCell activation purposes. That is, the RS availability indication signaling 318 may be a dynamic indication from the BS to the UE for the latter to use the periodic RS 310 to perform tracking loops such as power tracking loops (e.g., automatic gain control (AGC)), frequency tracking loops, time tracking loops, etc., for the activation of the SCell 312.

In some aspects, as noted above, the BS can transmit to the UE an activation command 320 to activate the SCell 312. In some instances, the activation command 320 may be carried by a PDSCH. For example, the BS may transmit the activation command 320 in a MAC-CE carried by the PDSCH. The PDSCH may be associated with, and preceded by, a PDCCH including downlink control information (DCI) scheduling the PDSCH. In some instances, the activation command 320 may include the RS availability indication signaling 318, i.e., the RS availability indication signaling 318 may be carried by the activation command 320. In some instances, the RS availability indication signaling 318 may be a standalone signaling, i.e., may not be carried by the activation command 320 (but rather carrier by another message).

In some instances, in response to receiving the activation command 320, the UE may transmit a HARQ-ACK 320 indicating that the activation command 230 has been received. The UE transmits the HARQ-ACK 320 according to a HARQ communication protocol after a duration T_{HARQ} 322. For example, if the UE receives the activation command 320 at time T0 326, the UE may transmit the HARQ-ACK 320 at time T1 after a delay of T_{HARQ} 322. In some cases, T_{HARQ} may be representative of the timing between the DL data transmission including the activation command 320 and the transmission by the UE of the acknowledgement HARQ-ACK 316. In some aspects, the duration T_{HARQ} 322 may be predetermined based on a certain wireless communication protocol. In some other aspects, the duration T_{HARQ} 322 can be based on UE capabilities (e.g., the time associated with the UE decoding the DL data including the activation command 320, etc.).

In some aspects, the BS may transmit the RS availability indication signaling 318 for the periodic RS 310 (e.g., along with or carried by the activation command 320) when the RS occasion that is configured for receiving the periodic RS 310 at the UE falls within a time window 306 that starts at time T2 336, which is at least a threshold duration 314 after the UE transmits the HARQ-ACK 316. As noted above, the UE may transmit to the BS the HARQ-ACK 316 at time T1 T_{HARQ} 322 duration after receiving the activation command 320 at time TO. In such cases, the start time T2 336 of the time window 306 may be after at least enough time has passed for the activation command 320 received at time T0 326 to have taken effect. For example, the threshold duration 314 may be no less than the amount of time after the HARQ-ACK 316 is transmitted to the BS that may be needed for the activation command 320 to take effect at the UE. That is, in some instances, the BS may transmit the RS availability indication signaling 318 for the periodic RS 310 when the RS occasion that is configured for receiving the periodic RS 310 at the UE falls within a time window 306 that starts after a threshold duration 314 after the UE transmits the HARQ-ACK 316, the threshold duration 314 being the minimum amount of time (e.g., after the HARQ-ACK 316 is transmitted) it may take for the activation command 320 to take effect at the UE. In some cases, the threshold duration 314 can be in the range from about 2 ms to about 4 ms, in the range from about 2.5 ms to about 3.5 ms, substantially equal to about 3 ms, etc. In some instances, the time window 306 may be viewed as the activation phase of the SCell 312.

In some aspects, the end time T3 of the time window 306 may be after the RS occasion for receiving the periodic RS 310 but at or before the next SSB 308c. That is, the BS may transmit the RS availability indication signaling 318 for the periodic RS 310 when the RS occasion that is configured for receiving the periodic RS 310 at the UE falls within a time window 306 that has an end time T3 that is before the next SSB 308c. In some instances, the end time T3 of the time window 306 may be configured or defined in wireless communication standards so as to reduce or minimize the SCell activation latency. That is, to reduce or minimize SCell activation latency, the BS may transmit the RS availability indication signaling 318 for the periodic RS 310 that is received at the UE via the RS occasion that is earliest in time (e.g., or at least one of the first few RS occasions) within the time window 306. As such, the end time T3 of the time window 306 may be well before the next SSB 308c. For example, the end time T3 may be no farther than about three quarter of the periodicity of the SSB transmissions 308 measured from the transmission of the last SSB 308b. In some instances, the time window 306 may have a width or duration that is less than the periodicity of the SSB transmissions 308 (e.g., no greater than about 80%, about 70%, about 60%, about 50%, about 40%, about 25%, etc., including values and subranges therebetween, of the periodicity) In some aspects, the end time T3 and/or the start time T2 may be configured by the BS.

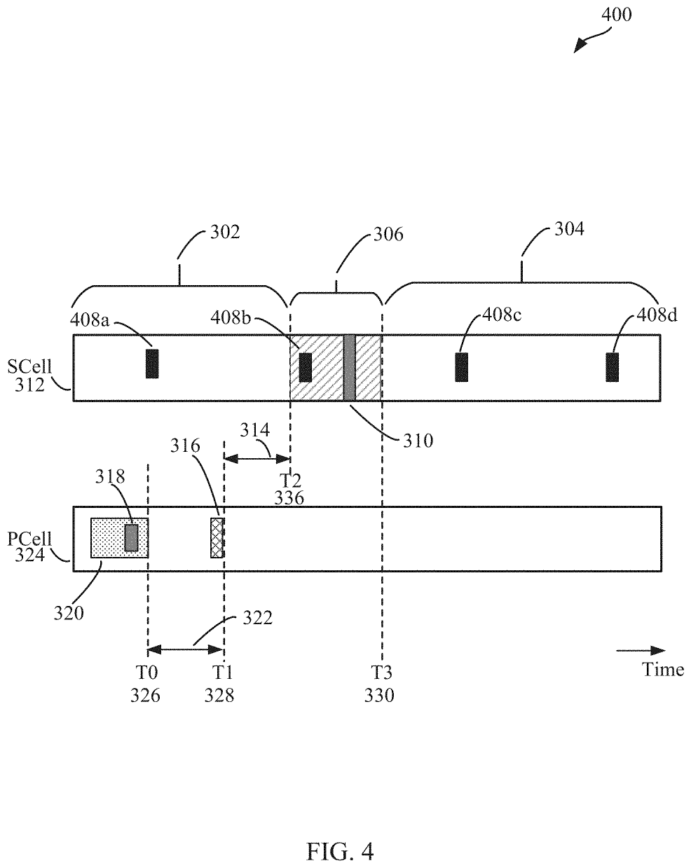

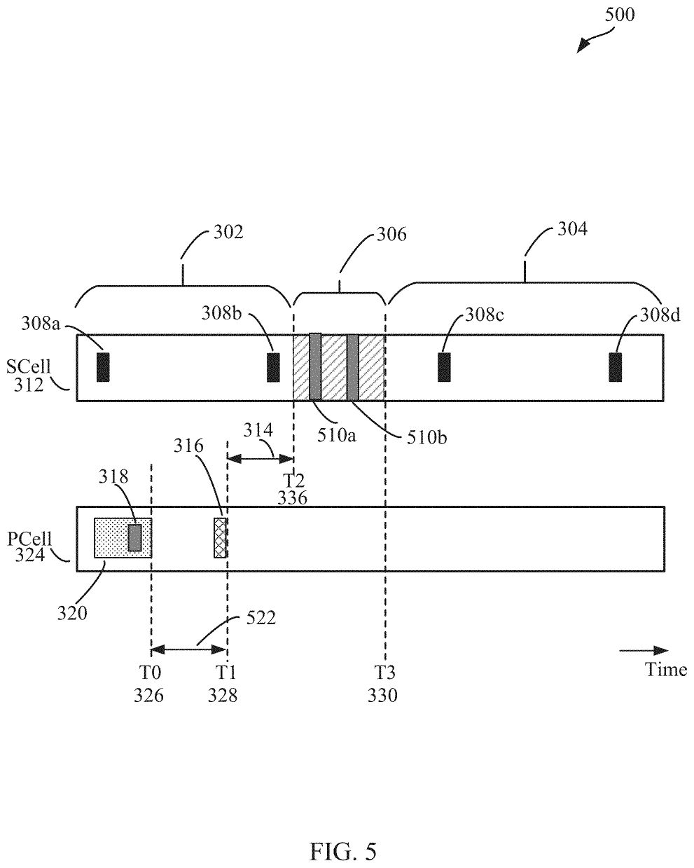

In some aspects, one or more of the SSBs transmitted by the BS to the UE on the SCell 312 may be within the time window 306 but before the occasion of the periodic RS 310 that is configured to be used by the UE for SCell activation functions (e.g., for performing tracking loops). For example, FIG. 4 shows an example non-limiting illustration where one of the configured SSBs 408a-408d, SSB 408b is transmitted via a SSB occasion that is within the time window 306 but before the RS occasion for receiving the periodic RS 310 at the UE on the SCell 312. FIG. 5 shows an example illustration that is substantially similar to that of FIG. 4, except that SSB 408b is received at the UE on the SCell prior to the RS occasion for the periodic RS 310. In such cases, SCell activation latency may be reduced if the UE uses the SSB 408b (e.g., instead of the periodic RS 310) for SCell activation functions. As such, in such cases, when the UE detects SSB 408b before the periodic RS 310 is transmitted to or received at the UE, the UE may perform measurements on one or more of the reference signals carried by the SSB 408b to perform various procedures associated with activating the SCell 312. That is, as explained above, each SSB 408 may include a plurality of reference signals, including primary synchronization signals (PSS), secondary synchronization signals (SSS), and physical broadcast channel demodulation reference signals (PBCH-DM-RS). The UE can perform measurements on one or more of these reference signals to perform various procedures associated with activating the SCell 312, such as but not limited to, power tracking loops (e.g., AGC), frequency tracking loops, time tracking loops, etc., to tune the receiver at the UE in preparation of operating in the SCell 312. In such instances, i.e., when using the SSB 408b that is within the time window 306 but prior in time than the periodic RS 310, the UE may not use or refraining from using the periodic RS for said SCell activation activities.

FIG. 5 shows an example illustration of the use of multiple periodic reference signals and a RS availability indication signaling for fast activation of a secondary cell, according to some aspects of the present disclosure. In some aspects, FIG. 5 shows an example illustration that is substantially similar to that of FIG. 3, except that FIG. 5 shows multiple periodic reference signals (RSs) 510a, 510b that are within the time window 306. In such instances, the UE and the BS may assume or agree which one of the multiple periodic RSs 510a, 510b that is indicated by the RS availability indication signaling 318 (e.g., so that one periodic RS may be used by the UE for SCell activation purposes as discussed above). For example, the UE and the BS may assume or agree that when there is more than one periodic RSs 510a, 510b in the time window 306, the RS availability indication signaling 318 refers to the first periodic RS 510a of the multiple periodic RSs 510a, 510b (e.g., to reduce or minimize SCell activation latency). In some instances, the UE and the BS may agree on or assume any one of the multiple periodic RSs 510a, 510b that is indicated by the RS availability indication signaling 318.

In some aspects, as noted above, there can be multiple periodic RSs 510a, 510b that fall within the time window 306. In some instances, the BS may configure multiple RS occasions on the SCell 312 for receiving RS at the UE on the SCell, and at least more than one of these configured RS occasions may fall within the time window 306. In some instances, the multiple configured RS occasions on the SCell 312 (e.g., those that may or may not fall within the time window 306) may be configured by the same RS resource configuration or by different RS resource configurations from the BS. In some instances, these multiple RS occasions may be configured for idle or inactive mode operation purposes by the UE on the SCell when the UE is in an idle or inactive mode (e.g., before the UE enters the activation phase 304 (i.e., when the UE is in the deactivated phase 302 or activation phase 306, for example)). In some cases, some of these multiple RS occasions may fall within the time window 306 as discussed above, and in those cases, the RS occasions that fall within the time window 306 may be configured to receive periodic RS 510a, 510b that may be used by the UE to perform tracking loops for activating the SCell 312.

In some aspects, the BS may provide an indication about which one of the multiple periodic RSs 510a, 510b that is indicated by the RS availability indication signaling 318. That is, the BS may indicate the RS occasion, of the multiple RS occasions configured for receiving the periodic RSs 510a, 510b, that is indicated by the RS availability indication signaling 318. In such cases, the UE may use the indicated periodic RS for performing tracking loops associated with the activation of the SCell 312. In some instances, the network or the BS may reuse the field in an aperiodic triggering signaling that is transmitted by the BS to the UE to trigger an aperiodic RS to indicate the RS occasion, of the multiple RS occasions configured for receiving the periodic RSs 510a, 510b, that is indicated by the RS availability indication signaling 318. For example, the field in the aperiodic triggering signaling that indicates the triggering time offset if an aperiodic reference signal is triggered may be reused or repurposed to indicate the RS occasion of the multiple RS occasions configured for receiving the periodic RSs 510a, 510b, that is indicated by the RS availability indication signaling 318.

In some aspects, the network (e.g., the BS) may also transmit to the UE (e.g., on the PCell) an aperiodic triggering signaling that is configured to indicate to the UE whether an aperiodic RS is triggered or not. In some instances, the aperiodic triggering signaling may be carried by a MAC-CE or a PDCCH message. In some cases, such an aperiodic triggering signaling may be considered by the UE as an implicit indication from the BS to use, or not use, the periodic RS (e.g., 310) that are transmitted by the BS to the UE via the configured RS occasions for SCell activation purposes. For example, the BS may transmit to the UE the aperiodic triggering signaling indicating that no aperiodic RS for use in SCell activation has been transmitted to the UE. In such cases, the UE may consider the aperiodic triggering signaling as an indication that a periodic RS has been transmitted via one of the configured RS occasions and that the UE can use said periodic RS for performing SCell activation functions (e.g., perform or update tracking loops). In some instances, the aperiodic triggering signaling may indicate that an aperiodic RS has been transmitted to the UE for use in activating the SCell 312, and in such cases, the UE may consider such aperiodic triggering signaling as an indication not to use a periodic RS to perform SCell activation functions (e.g., or as an indication that no periodic RS has been transmitted by the BS to the UE).

In some aspects, the aperiodic triggering signaling may include an explicit indication indicating the RS occasion of the multiple RS occasions configured for receiving the periodic RSs 510a, 510b, to be used for activating the SCell 312 (i.e., an explicit indication indicating the RS occasion that is indicated by the RS availability indication signaling 318). For example, the aperiodic triggering signaling may include a value defined for such function or indication in the codepoint of the field in the aperiodic triggering signaling that indicates whether the aperiodic RS is triggered or not.

In some aspects, as discussed above with reference to FIGS. 3, 4, and 5, the UE may receive a periodic RS (e.g., 310 or 510) on the SCell along with an RS availability indication signaling 318 (e.g., via an activation command 320 on the PCell) on the PCell, the RS availability indication signaling 318 indicating the availability of the periodic RS for use in performing (e.g., updating) tracking loops such as but not limited to power tracking loops (e.g., AGC), frequency tracking loops, or time tracking loops. The UE may receive the periodic RS 310 or 510 during the activation phase or time window 306, and may perform measurements on the periodic RS 310 or 510 to perform various procedures associated with activating the SCell 312, such as updating the tracking loops discussed above. In some instances, at the end of the activation phase or time window 306 at the end time T3 330, the SCell 312 may be activated and enter an activated phase 304.

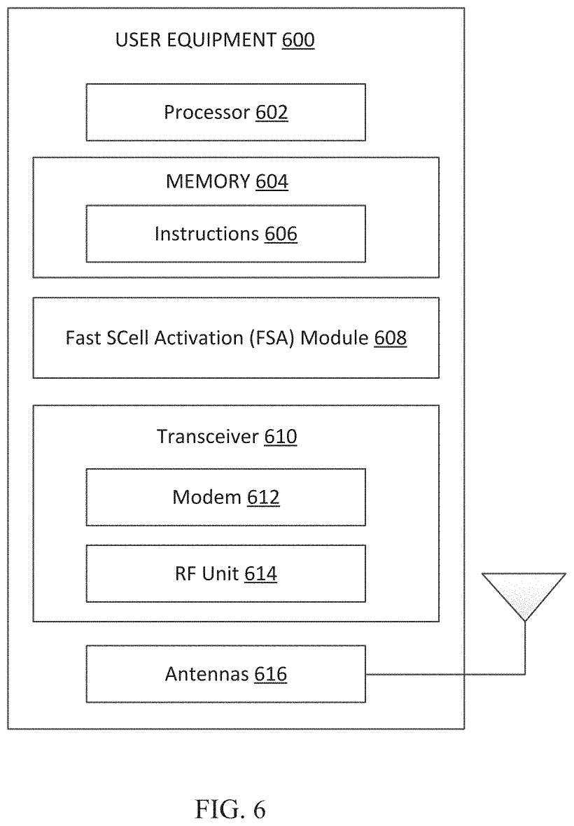

FIG. 6 is a block diagram of an exemplary UE 600 according to some aspects of the present disclosure. The UE 600 may be a UE 115 in the network 100 as discussed above in FIG. 1. As shown, the UE 600 may include a processor 602, a memory 604, a FSA module 608, a transceiver 610 including a modem subsystem 612 and a RF unit 614, and one or more antennas 616. These elements may be in direct or indirect communication with each other, for example via one or more buses.

The processor 602 may have various features as a specific-type processor. For example, these may include a CPU, a DSP, an ASIC, a controller, a FPGA device, another hardware device, a firmware device, or any combination thereof configured to perform the operations described herein. The processor 602 may also be implemented as a combination of computing devices, e.g., a combination of a DSP and a microprocessor, a plurality of microprocessors, one or more microprocessors in conjunction with a DSP core, or any other such configuration.

The memory 604 may include a cache memory (e.g., a cache memory of the processor 602), RAM, MRAM, ROM, PROM, EPROM, EEPROM, flash memory, a solid state memory device, one or more hard disk drives, memristor-based arrays, other forms of volatile and non-volatile memory, or a combination of different types of memory. In some aspects, the memory 604 may include a non-transitory computer-readable medium. The memory 604 may store instructions 606. The instructions 606 may include instructions that, when executed by the processor 602, cause the processor 602 to perform operations described herein, for example, aspects of FIGS. 1-5 and 8. Instructions 606 may also be referred to as program code. The program code may be code for causing a wireless communication device to perform these operations, for example by causing one or more processors (such as processor 602) to control or command the wireless communication device to do so. The terms “instructions” and “code” should be interpreted broadly to include any type of computer-readable statement(s). For example, the terms “instructions” and “code” may refer to one or more programs, routines, sub-routines, functions, procedures, etc. “Instructions” and “code” may include a single computer-readable statement or many computer-readable statements.

The FSA module 608 may be implemented via hardware, software, or combinations thereof. For example, the FSA module 608 may be implemented as a processor, circuit, and/or instructions 606 stored in the memory 604 and executed by the processor 602. In some examples, the FSA module 608 can be integrated within the modem subsystem 612. For example, the FSA module 608 can be implemented by a combination of software components (e.g., executed by a DSP or a general processor) and hardware components (e.g., logic gates and circuitry) within the modem subsystem 612. The FSA module 608 may be used for various aspects of the present disclosure, for example, aspects of FIGS. 1-5 and 8. For example, the FSA module 608 can be configured to receive, from a base station (BS) and on a primary cell (PCell), an activation command configured to activate a secondary cell (SCell). Further, the FSA module 608 can be configured to receive, from the BS and on the PCell, a signaling configured to indicate availability of a periodic reference signal (RS) that is different from a synchronization signal block (SSB) on the SCell for use in activating the SCell. In addition, the FSA module 608 can be configured to perform, in response to the signaling being received, tracking loop to activate the SCell.

As shown, the transceiver 610 may include the modem subsystem 612 and the RF unit 614. The transceiver 610 can be configured to communicate bi-directionally with other devices, such as the UEs 115, and/or another core network element. The modem subsystem 612 may be configured to modulate and/or encode data according to a MCS, e.g., a LDPC coding scheme, a turbo coding scheme, a convolutional coding scheme, a digital beamforming scheme, etc. The RF unit 614 may be configured to process (e.g., perform analog to digital conversion or digital to analog conversion, etc.) modulated/encoded data (e.g., PSBCH, sidelink RMSI, PSSCH, PSCCH, PSFCH, PC5-RRC configuration, control commands) from the modem subsystem 612 (on outbound transmissions) or of transmissions originating from another source such as a UE 115. The RF unit 614 may be further configured to perform analog beamforming in conjunction with the digital beamforming. Although shown as integrated together in transceiver 610, the modem subsystem 612 and/or the RF unit 614 may be separate devices that are coupled together at a UE 115 to enable the UE 115 to communicate with other devices.

The RF unit 614 may provide the modulated and/or processed data, e.g. data packets (or, more generally, data messages that may contain one or more data packets and other information), to the antennas 616 for transmission to one or more other devices. This may include, for example, transmission of information to complete attachment to a network and communication with a camped UE 115 according to some aspects of the present disclosure. The antennas 616 may further receive data messages transmitted from other devices and provide the received data messages for processing and/or demodulation at the transceiver 610. The transceiver 610 may provide the demodulated and decoded data (e.g., PSCCH, PSSCH, PSFCH, measurement data, sensor data records, activation command, availability indicator signaling, etc.) to the FSA module 608 for processing. The antennas 616 may include multiple antennas of similar or different designs in order to sustain multiple transmission links.

In some aspects, the transceiver 610 is configured to communicate with the base station (BS) to receive, from a base station (BS) and on a primary cell (PCell), an activation command configured to activate a secondary cell (SCell). Further, the transceiver 610 is configured to communicate with the base station (BS) to receive, from the BS and on the PCell, a signaling configured to indicate availability of a periodic reference signal (RS) that is different from a synchronization signal block (SSB) on the SCell for use in activating the SCell.

In an aspect, the UE 600 can include multiple transceivers 610 implementing different RATs (e.g., NR and LTE). In an aspect, the UE 600 can include a single transceiver 610 implementing multiple RATs (e.g., NR and LTE). In an aspect, the transceiver 610 can include various components, where different combinations of components can implement different RATs.

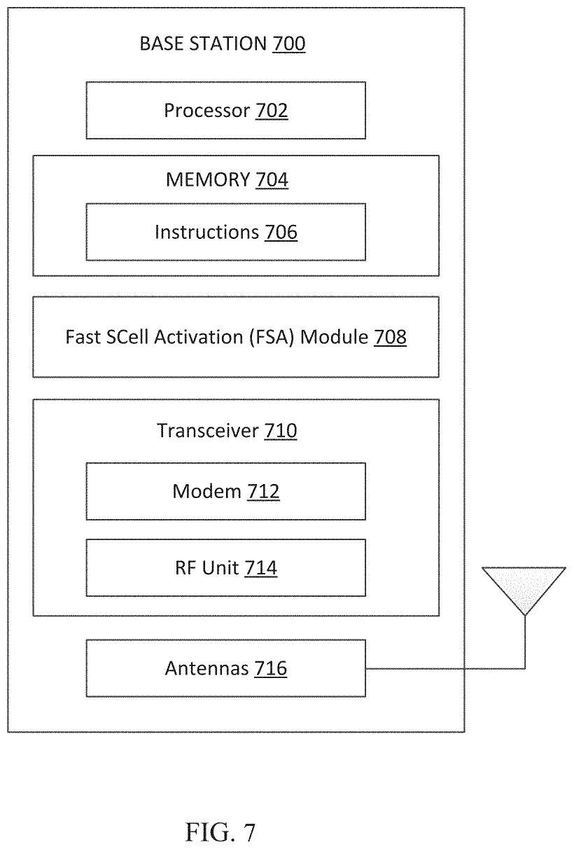

FIG. 7 is a block diagram of an exemplary base station (BS) 700 according to some aspects of the present disclosure. The BS 700 may be a BS 105 discussed above in FIG. 1. As shown, the BS 700 may include a processor 702, a memory 704, a FSA module 708, a transceiver 710 including a modem subsystem 712 and a radio frequency (RF) unit 714, and one or more antennas 716. These elements may be in direct or indirect communication with each other, for example via one or more buses.

The processor 702 may include a central processing unit (CPU), a digital signal processor (DSP), an application specific integrated circuit (ASIC), a controller, a field programmable gate array (FPGA) device, another hardware device, a firmware device, or any combination thereof configured to perform the operations described herein. The processor 702 may also be implemented as a combination of computing devices, e.g., a combination of a DSP and a microprocessor, a plurality of microprocessors, one or more microprocessors in conjunction with a DSP core, or any other such configuration.

The memory 704 may include a cache memory (e.g., a cache memory of the processor 702), random access memory (RAM), magnetoresistive RAM (MRAM), read-only memory (ROM), programmable read-only memory (PROM), erasable programmable read only memory (EPROM), electrically erasable programmable read only memory (EEPROM), flash memory, solid state memory device, hard disk drives, other forms of volatile and non-volatile memory, or a combination of different types of memory. In an aspect, the memory 704 includes a non-transitory computer-readable medium. The memory 704 may store, or have recorded thereon, instructions 706. The instructions 706 may include instructions that, when executed by the processor 702, cause the processor 702 to perform the operations described herein in connection with aspects of the present disclosure, for example, aspects of FIGS. 1-5 and 8. Instructions 706 may also be referred to as program code, which may be interpreted broadly to include any type of computer-readable statement(s) as discussed above with respect to FIG. 6.

The FSA module 708 may be implemented via hardware, software, or combinations thereof. For example, the FSA module 708 may be implemented as a processor, circuit, and/or instructions 706 stored in the memory 704 and executed by the processor 702. In some examples, the FSA module 708 can be integrated within the modem subsystem 712. For example, the FSA module 708 can be implemented by a combination of software components (e.g., executed by a DSP or a general processor) and hardware components (e.g., logic gates and circuitry) within the modem subsystem 712.

The FSA module 708 may be used for various aspects of the present disclosure, for example, aspects of FIGS. 1-5 and 8. The FSA module 708 may be configured to transmit, to the (UE) and on a primary cell (PCell), an activation command configured to activate a secondary cell (SCell). Further, the FSA module 708 may be configured to transmit, to the UE and on the PCell, a signaling configured to indicate availability of a periodic reference signal (RS) on the SCell for use in activating the SCell.

In some aspects, the FSA module 708 may be configured to transmit to the UE a system information block (SIB) including a RS configuration for a periodic RS occasion for receiving the periodic RS. In some aspects, the FSA module 708 may be configured to receive, from the UE, a hybrid automatic repeat request-acknowledgment (HARQ-ACK) for the received activation command, the periodic RS occasion for receiving the periodic RS falling within a time window starting at least a threshold duration after the transmitting the HARQ-ACK.

In some aspects, the FSA module 708 may be configured to transmit, to the UE and within the time window but prior to the periodic RS occasion, a SSB for use in activating the SCell. In some aspects, the periodic RS occasion includes a plurality of RS occasions and the FSA module 708 may be configured to transmit, to the UE, an indication indicating an RS occasion of the plurality of RS occasions via which the periodic RS is received at the UE.

In some aspects, the FSA module 708 may be configured to transmit to the UE an indication for the UE to use the periodic RS to perform the tracking loop to activate the SCell. In some aspects, the transceiver is further configured to transmit an indication indicating whether an aperiodic RS is transmitted by the BS to the UE to activate the SCell.

As shown, the transceiver 710 may include a modem subsystem 712 and an RF unit 714. The transceiver 710 can be configured to communicate bi-directionally with other devices, such as the BSs 105. The modem subsystem 712 may be configured to modulate and/or encode the data from the memory 704 according to a modulation and coding scheme (MCS), e.g., a low-density parity check (LDPC) coding scheme, a turbo coding scheme, a convolutional coding scheme, a digital beamforming scheme, etc. The RF unit 714 may be configured to process (e.g., perform analog to digital conversion or digital to analog conversion, etc.) modulated/encoded data (e.g., PUSCH signal, UL data, SRSs, UE capability reports, RI reports) from the modem subsystem 712 (on outbound transmissions) or of transmissions originating from another source such as a UE 115 or a BS 105. The RF unit 714 may be further configured to perform analog beamforming in conjunction with the digital beamforming. Although shown as integrated together in transceiver 710, the modem subsystem 712 and the RF unit 714 may be separate devices that are coupled together at the BS 700 to enable the BS 700 to communicate with other devices.

The RF unit 714 may provide modulated and/or processed data, e.g. data packets (or, more generally, data messages that may contain one or more data packets and other information), to the antennas 716 for transmission to one or more other devices. The antennas 716 may further receive data messages transmitted from other devices. The antennas 716 may provide the received data messages for processing and/or demodulation at the transceiver 710. The transceiver 710 may provide the demodulated and decoded data (e.g., PDSCH signal, PDCCH, DL data, activation command, availability indictor signaling, etc.) to the FSA 708. The antennas 716 may include multiple antennas of similar or different designs in order to sustain multiple transmission links. The RF unit 714 may configure the antennas 716.

In an aspect, the BS 700 can include multiple transceivers 710 implementing different RATs (e.g., NR and LTE). In an aspect, the BS 700 can include a single transceiver 710 implementing multiple RATs (e.g., NR and LTE). In an aspect, the transceiver 710 can include various components, where different combinations of components can implement different RATs.

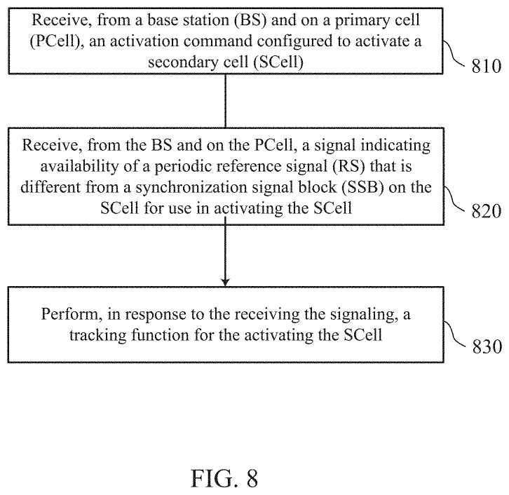

FIG. 8 is a flow diagram of a wireless communication method 800 according to some aspects of the present disclosure. Aspects of the method 800 can be executed by a computing device (e.g., a processor, processing circuit, and/or other suitable component) of a wireless communication device or other suitable means for performing the steps. For example, a wireless communication device, such as the UEs 115 may utilize one or more components, such as the processor 602, the memory 604, the FSA module 608, the transceiver 610, the modem 612, and the one or more antennas 616, to execute the steps of method 800. As illustrated, the method 800 includes a number of enumerated steps, but aspects of the method 800 may include additional steps before, after, and in between the enumerated steps. In some aspects, one or more of the enumerated steps may be omitted or performed in a different order.

At block 810, a UE (e.g., the UEs 115) can receive, from a base station (BS) and on a primary cell (PCell), an activation command configured to activate a secondary cell (SCell). In some instances, the UE may utilize one or more components, such as the processor 602, the memory 604, the FSA module 608, the transceiver 610, the modem 612, and the one or more antennas 616, to receive, from a base station (BS) and on a primary cell (PCell), an activation command configured to activate a secondary cell (SCell).

At block 820, the UE can receive, from the BS and on the PCell, a signaling configured to indicate availability of a periodic reference signal (RS) on the SCell for use in activating the SCell. In some instances, the UE may utilize one or more components, such as the processor 602, the memory 604, the FSA module 608, the transceiver 610, the modem 612, and the one or more antennas 616, to receive, from the BS and on the PCell, a signaling configured to indicate availability of a periodic reference signal (RS) that is different from a synchronization signal block (SSB) on the SCell for use in activating the SCell.

At block 830, the UE can perform, in response to the signaling being received, tracking loop to activate the SCell. In some instances, the UE may utilize one or more components, such as the processor 602, the memory 604, the FSA module 608, the transceiver 610, the modem 612, and the one or more antennas 616, to perform, in response to the signaling being received, tracking loop to activate the SCell.

In some aspects, the performing the tracking loop includes updating a time tracking loop, a frequency tracking loop, or a power tracking loop.

Some aspects of method 800 further comprise receiving, from the BS, a system information block (SIB) including a RS configuration for a periodic RS occasion for receiving the periodic RS. Further, method 800 may comprise transmitting, to the BS, a hybrid automatic repeat request-acknowledgment (HARQ-ACK) for the received activation command, the periodic RS occasion for receiving the periodic RS falling within a time window starting at least a threshold duration after the transmitting the HARQ-ACK. In some aspects, the threshold duration is an amount of time for the activation command to take effect at the UE.

In some aspects, a start of the time window and/or an end of the time window are configured by the BS. In some aspects, an end of the time window occurs at or before a next occasion for receiving, at the UE, a synchronization signal block (SSB). Some aspects of method 800 further comprise receiving, from the BS and within the time window but prior to the periodic RS occasion, a SSB for use in activating the SCell, the performing including using the SSB to perform the tracking loop for the activating the SCell. In some aspects, the periodic RS is not used to perform the tracking loop for the activating the SCell.

In some aspects, a duration of the time window is less than a periodicity of SSB transmissions from the BS to the UE. In some aspects, the periodic RS occasion includes a plurality of RS occasions; and the periodic RS is received via an RS occasion of the plurality of RS occasions that is first in time. In some aspects, the periodic RS occasion includes a plurality of RS occasions, and some aspects of method 800 further comprise receiving, from the B S, an indication indicating an RS occasion of the plurality of RS occasions via which the periodic RS is received at the UE.

In some aspects of method 800, the performing includes using the periodic RS to perform the tracking loop for the activating the SCell. In some aspects, the method 800 further comprises receiving, from the BS, an indication for the UE to use the periodic RS to perform the tracking loop for the activating the SCell.

Some aspects of method 800 further comprise receiving, from the BS, an indication indicating whether an aperiodic RS is transmitted by the BS to the UE for the activating the SCell. In some aspects, the indication indicates that the periodic RS is not transmitted by the BS to the UE for the activating the SCell. In some aspects, the indication is received via a medium access control-control element (MAC-CE) message or a physical downlink control channel (PDCCH) message.

In some aspects of method 800, the activation command includes the signaling. In some aspects, the activation command is received via a MAC-CE message.

Recitations of Some Aspects of the Present Disclosure

Aspect 1: A method of wireless communication performed by a user equipment (UE), the method comprising: receiving, from a base station (BS) and on a primary cell (PCell), an activation command configured to activate a secondary cell (SCell); receiving, from the BS and on the PCell, a signal configured to indicate availability of a periodic reference signal (RS) on the SCell for use in activating the SCell; and performing, in response to the receiving the signal, tracking loop for the activating the SCell.

Aspect 2: The method of aspect 1, wherein the performing the tracking loop includes updating a time tracking loop, a frequency tracking loop, or a power tracking loop.

Aspect 3: The method of aspect 1 or 2, further comprising receiving, from the BS, a system information block (SIB) including a RS configuration for a periodic RS occasion for receiving the periodic RS.

Aspect 4: The method of aspect 3, further comprising transmitting, to the BS, a hybrid automatic repeat request-acknowledgment (HARQ-ACK) for the received activation command, the periodic RS occasion for receiving the periodic RS falling within a time window starting at least a threshold duration after the transmitting the HARQ-ACK.

Aspect 5: The method of aspect 4, wherein the threshold duration is an amount of time for the activation command to take effect at the UE.

Aspect 6: The method of aspect 4 or 5, wherein a start of the time window and/or an end of the time window are configured by the BS.

Aspect 7: The method of any of aspects 4-6, wherein an end of the time window occurs at or before a next occasion for receiving, at the UE, a synchronization signal block (SSB).

Aspect 8: The method of any of aspects 4-7, further comprising: receiving, from the BS and within the time window but prior to the periodic RS occasion, a SSB for use in activating the SCell, the performing including using the SSB to perform the tracking loop for the activating the SCell.

Aspect 9: The method of aspect 8, wherein the periodic RS is not used to perform the tracking loop for the activating the SCell.

Aspect 10: The method of any of aspects 4-9, wherein a duration of the time window is less than a periodicity of SSB transmissions from the BS to the UE.

Aspect 11: The method of any of aspects 3-10, wherein the periodic RS occasion includes a plurality of RS occasions; and the periodic RS is received via an RS occasion of the plurality of RS occasions that is first in time.

Aspect 12: The method of any of aspects 3-11, wherein the periodic RS occasion includes a plurality of RS occasions, the method further comprising: receiving, from the BS, an indication indicating an RS occasion of the plurality of RS occasions via which the periodic RS is received at the UE.

Aspect 13: The method of aspect 1-12, wherein the performing includes using the periodic RS to perform the tracking loop for the activating the SCell.

Aspect 14: The method of aspect 13, further comprising receiving, from the BS, an indication for the UE to use the periodic RS to perform the tracking loop for the activating the SCell.

Aspect 15: The method of any of aspects 1-14, further comprising receiving, from the BS, an indication indicating whether an aperiodic RS is transmitted by the BS to the UE for the activating the SCell.

Aspect 16: The method of any of aspects 1-15, wherein the indication indicates that the periodic RS is not transmitted by the BS to the UE for the activating the SCell.

Aspect 17: The method of any of aspects 14-16, wherein the indication is received via a medium access control-control element (MAC-CE) message or a physical downlink control channel (PDCCH) message.

Aspect 18: The method of any of aspects 1-17, the activation command includes the signal.

Aspect 19: The method of any of aspects 1-18, the activation command is received via a MAC-CE message.

Aspect 20: A user equipment (UE), comprising: a memory; a processor coupled to the memory; and a transceiver coupled to the processor, the UE configured to perform the methods of aspects 1-19.

Aspect 21: A user equipment (UE) comprising means for performing the methods of aspects 1-19.

Aspect 22: A non-transitory computer-readable medium (CRM) having program code recorded thereon, the program code comprises code for causing a UE to perform the methods of aspects 1-19.

It should be noted that the methods described herein describe possible implementations, and that the operations and the steps may be rearranged or otherwise modified and that other implementations are possible. Further, aspects from two or more of the methods may be combined.

Although aspects of an LTE, LTE-A, LTE-A Pro, or NR system may be described for purposes of example, and LTE, LTE-A, LTE-A Pro, or NR terminology may be used in much of the description, the techniques described herein are applicable beyond LTE, LTE-A, LTE-A Pro, or NR networks. For example, the described techniques may be applicable to various other wireless communications systems such as Ultra Mobile Broadband (UMB), Institute of Electrical and Electronics Engineers (IEEE) 802.11 (Wi-Fi), IEEE 802.16 (WiMAX), IEEE 802.20, Flash-OFDM, as well as other systems and radio technologies not explicitly mentioned herein.

Information and signals described herein may be represented using any of a variety of different technologies and techniques. For example, data, instructions, commands, information, signals, bits, symbols, and chips that may be referenced throughout the description may be represented by voltages, currents, electromagnetic waves, magnetic fields or particles, optical fields or particles, or any combination thereof.

The various illustrative blocks and components described in connection with the disclosure herein may be implemented or performed with a general-purpose processor, a DSP, an ASIC, a CPU, an FPGA or other programmable logic device, discrete gate or transistor logic, discrete hardware components, or any combination thereof designed to perform the functions described herein. A general-purpose processor may be a microprocessor, but in the alternative, the processor may be any processor, controller, microcontroller, or state machine. A processor may also be implemented as a combination of computing devices (e.g., a combination of a DSP and a microprocessor, multiple microprocessors, one or more microprocessors in conjunction with a DSP core, or any other such configuration).

The functions described herein may be implemented in hardware, software executed by a processor, firmware, or any combination thereof. If implemented in software executed by a processor, the functions may be stored on or transmitted over as one or more instructions or code on a computer-readable medium. Other examples and implementations are within the scope of the disclosure and appended claims. For example, due to the nature of software, functions described herein may be implemented using software executed by a processor, hardware, firmware, hardwiring, or combinations of any of these. Features implementing functions may also be physically located at various positions, including being distributed such that portions of functions are implemented at different physical locations.

Computer-readable media includes both non-transitory computer storage media and communication media including any medium that facilitates transfer of a computer program from one place to another. A non-transitory storage medium may be any available medium that may be accessed by a general-purpose or special purpose computer. By way of example, and not limitation, non-transitory computer-readable media may include random-access memory (RAM), read-only memory (ROM), electrically erasable programmable ROM (EEPROM), flash memory, compact disk (CD) ROM or other optical disk storage, magnetic disk storage or other magnetic storage devices, or any other non-transitory medium that may be used to carry or store desired program code means in the form of instructions or data structures and that may be accessed by a general-purpose or special-purpose computer, or a general-purpose or special-purpose processor. Also, any connection is properly termed a computer-readable medium. For example, if the software is transmitted from a web site, server, or other remote source using a coaxial cable, fiber optic cable, twisted pair, digital subscriber line (DSL), or wireless technologies such as infrared, radio, and microwave, then the coaxial cable, fiber optic cable, twisted pair, DSL, or wireless technologies such as infrared, radio, and microwave are included in the definition of computer-readable medium. Disk and disc, as used herein, include CD, laser disc, optical disc, digital versatile disc (DVD), floppy disk and Blu-ray disc where disks usually reproduce data magnetically, while discs reproduce data optically with lasers. Combinations of the above are also included within the scope of computer-readable media.

As used herein, including in the claims, “or” as used in a list of items (e.g., a list of items prefaced by a phrase such as “at least one of” or “one or more of”) indicates an inclusive list such that, for example, a list of at least one of A, B, or C means A or B or C or AB or AC or BC or ABC (i.e., A and B and C). Also, as used herein, the phrase “based on” shall not be construed as a reference to a closed set of conditions. For example, an example step that is described as “based on condition A” may be based on both a condition A and a condition B without departing from the scope of the present disclosure. In other words, as used herein, the phrase “based on” shall be construed in the same manner as the phrase “based at least in part on.”

In the appended figures, similar components or features may have the same reference label. Further, various components of the same type may be distinguished by following the reference label by a dash and a second label that distinguishes among the similar components. If just the first reference label is used in the specification, the description is applicable to any one of the similar components having the same first reference label irrespective of the second reference label, or other subsequent reference label.

The description set forth herein, in connection with the appended drawings, describes example configurations and does not represent all the examples that may be implemented or that are within the scope of the claims. The term “example” used herein means “serving as an example, instance, or illustration,” and not “preferred” or “advantageous over other examples.” The detailed description includes specific details for the purpose of providing an understanding of the described techniques. These techniques, however, may be practiced without these specific details. In some instances, known structures and devices are shown in block diagram form in order to avoid obscuring the concepts of the described examples.

The description herein is provided to enable a person having ordinary skill in the art to make or use the disclosure. Various modifications to the disclosure will be apparent to a person having ordinary skill in the art, and the generic principles defined herein may be applied to other variations without departing from the scope of the disclosure. Thus, the disclosure is not limited to the examples and designs described herein, but is to be accorded the broadest scope consistent with the principles and novel features disclosed herein.

What is claimed is:

1. A method of wireless communication performed by a user equipment (UE), the method comprising:
receiving, from a base station (BS) on a primary cell (PCell), an activation command configured to activate a secondary cell (SCell);
receiving, from the BS and on the PCell, a signal indicating an availability of a periodic reference signal (RS) that is different from a synchronization signal block (SSB) on the Scell, the periodic RS being for use in activating the SCell; and
performing, in response to the receiving the signal, a tracking loop for the activating the SCell.

2. The method of claim 1, further comprising receiving, from the BS, a system information block (SIB) including a RS configuration for a periodic RS occasion for receiving the periodic RS.

3. The method of claim 2, further comprising:
transmitting, to the BS, a hybrid automatic repeat request-acknowledgment (HARQ-ACK) for the received activation command,
the periodic RS occasion for receiving the periodic RS falling within a time window starting at least a threshold duration after the transmitting the HARQ-ACK.

4. The method of claim 3, wherein the threshold duration is an amount of time for the activation command to take effect at the UE.

5. The method of claim 3, wherein a start of the time window and/or an end of the time window are configured by the BS.

6. The method of claim 3, wherein an end of the time window occurs at or before a next occasion for receiving, from the BS and at the UE, a SSB.

7. The method of claim 3, wherein a duration of the time window is less than a periodicity of SSB transmissions from the BS to the UE.

8. The method of claim 2, wherein:
the periodic RS occasion includes a plurality of RS occasions; and
the periodic RS is received via an RS occasion of the plurality of RS occasions that is first in time.

9. The method of claim 2, wherein the periodic RS occasion includes a plurality of RS occasions, the method further comprising:
receiving, from the B S, an indication indicating an RS occasion of the plurality of RS occasions via which the periodic RS is received at the UE.

10. The method of claim 1, wherein the performing the tracking loop includes at least one of:
updating a time tracking loop, a frequency tracking loop, or a power tracking loop; or
using the periodic RS to perform the tracking loop for the activating the SCell.

11. The method of claim 1, further comprising receiving, from the BS, an indication indicating whether an aperiodic RS is transmitted by the BS to the UE for the activating the SCell.

12. The method of claim 11, further comprising:
wherein the indication is received via a medium access control-control element (MAC-CE) message or a physical downlink control channel (PDCCH) message.

13. The method of claim 1, wherein the activation command includes the signal.

14. The method of claim 1, wherein the activation command is received via a MAC-CE message.

15. A user equipment (UE), comprising:
a memory;
a transceiver configured to:
receive, from a base station (BS) on a primary cell (PCell), an activation command configured to activate a secondary cell (SCell); and
receive, from the BS and on the PCell, a signal indicating an availability of a periodic reference signal (RS) that is different from a synchronization signal block (SSB) on the Scell, the periodic RS being for use in activating the SCell; and
a processor coupled to the transceiver and configured to:
perform, in response to the signal being received, a tracking loop to activate the SCell.

16. The UE of claim 15, wherein the transceiver is further configured to receive, from the BS, a system information block (SIB) including a RS configuration for a periodic RS occasion for receiving the periodic RS.

17. The UE of claim 16, wherein the transceiver is further configured to:
transmit, to the BS, a hybrid automatic repeat request-acknowledgment (HARQ-ACK) for the received activation command,
the periodic RS occasion for receiving the periodic RS falling within a time window starting at least a threshold duration after the transmitting the HARQ-ACK.

18. The UE of claim 17, wherein the threshold duration is an amount of time for the activation command to take effect at the UE.

19. The UE of claim 17, wherein a start of the time window and/or an end of the time window are configured by the BS.

20. The UE of claim 17, wherein an end of the time window occurs at or before a next occasion for receiving, at the UE, the SSB.

21. The UE of claim 17, wherein a duration of the time window is less than a periodicity of SSB transmissions from the BS to the UE.

22. The UE of claim 16, wherein:
the periodic RS occasion includes a plurality of RS occasions; and
the periodic RS is received via an RS occasion of the plurality of RS occasions that is first in time.

23. The UE of claim 16, wherein the periodic RS occasion includes a plurality of RS occasions,
the transceiver further configured to receive, from the BS, an indication indicating an RS occasion of the plurality of RS occasions via which the periodic RS is received at the UE.

24. The UE of claim 15, wherein the processor configured to perform the tracking comprises at least one of:
the processor configured to update a time tracking loop, a frequency tracking loop, or a power tracking loop; or
perform the tracking loop using the periodic RS.

25. The UE of claim 20, wherein the transceiver is further configured to receive, from the BS, an indication indicating whether an aperiodic RS is transmitted by the BS to the UE to activate the SCell.

26. The UE of claim 25, wherein the indication is received via a medium access control-control element (MAC-CE) message or a physical downlink control channel (PDCCH) message.

27. The UE of claim 15, wherein the activation command includes the signal.

28. The UE of claim 15, wherein the activation command is received via a MAC-CE message.

29. A non-transitory computer-readable medium (CRM) having program code recorded thereon, the program code comprising:
code for causing a user equipment (UE) to receive, from a base station (BS) on a primary cell (PCell), an activation command configured to activate a secondary cell (SCell);
code for causing the UE to receive, from the BS and on the PCell, a signal indicating an availability of a periodic reference signal (RS) that is different from a synchronization signal block (SSB) on the Scell, the periodic RS being for use in activating the SCell; and
code for causing the UE to perform, in response to the signal being received, a tracking loop to activate the SCell.

30. A user equipment (UE) comprising:
means for receiving, from a base station (BS) on a primary cell (PCell), an activation command configured to activate a secondary cell (SCell);
means for receiving, from the BS and on the PCell, a signal indicating an availability of a periodic reference signal (RS) that is different from a synchronization signal block (SSB) on the Scell, the periodic RS being for use in activating the SCell; and
means for performing, in response to the receiving the signal, a tracking loop for the activating the SCell.
